(19) United States
(12) Patent Application Publication
(10) Pub. No.: US 2011/0032449 A1
(43) Pub. Date: Feb. 10, 2011

(54) PERFORATED BACKLIGHT

(76) Inventors: David G. Freier, St Paul, MN (US); Raymond P. Johnston, Lake Elmo, MN (US); Steven H. Kong, Woodbury, MN (US)

Correspondence Address: 3M INNOVATIVE PROPERTIES COMPANY, PO BOX 33427, ST. PAUL, MN, 55133-3427, US

(21) Appl. No.: 12/866,409

(22) PCT Filed: Feb. 6, 2009
(86) PCT No.: PCT/US09/33349

§ 371 Date: Oct. 29, 2010

Related U.S. Application Data
(60) Provisional application No. 61/027,219, filed on Feb. 8, 2008.

(51) Int. Cl. G02F 1/13357; F21V 7/22

(52) U.S. Cl. 349/61; 362/606; 362/607

(57) ABSTRACT

A backlight includes a lower light guide having a specularly reflecting bottom surface and an opposing specularly reflecting perforated mirror film having a plurality of light transmission apertures. The specularly reflecting perforated mirror film has a polymeric multilayer structure, where non-perforated areas of the specularly reflecting perforated mirror film have a light reflectance value of 98% or greater and the specularly reflecting bottom surface has a light reflectance value of 98% or greater. A light collimating injector directs input light into the lower light guide. The light propagating generally parallel to the specularly reflecting perforated mirror film along a horizontal plane. The light collimating injector provides input rays into a vertical plane, the vertical plane being orthogonal to the horizontal plane, and forming an angle having an absolute value of 30 degrees or less with an intersection of the vertical and horizontal planes. An upper light cavity is disposed on the lower light guide. The upper light cavity has a light emission surface and a light input surface. The light input surface is at least partially defined by the specularly reflecting perforated mirror film. The upper light cavity has a thickness defined by the light emission surface and the light input surface. The thickness is equal to or greater than a distance between adjacent light transmission apertures.

### RELATED APPLICATIONS

This application claims the benefit of U.S. Provisional Patent Application No. 61/027,219, filed on Feb. 8, 2008, the disclosure of which is incorporated by reference herein in its entirety.

### FIELD

The present disclosure relates to perforated backlights and luminaires and particularly to a highly efficient edge-lit perforated backlight that provides uniform illumination.

### BACKGROUND

Backlights and luminaires are utilized in a variety of applications such as, for example, liquid crystal displays and commercial graphic displays. Presently, many popular systems for backlighting include direct-lit backlights, in which multiple lamps or a single serpentine-shaped lamp are arranged behind the display in the field of view of the user, or edge-lit backlights, in which the lamps are placed along one or more edges of a light guide located behind the display, so that the lamps are out of the field of view of the user.

Luminaires are also used in a variety of applications. A new trend is the use of LED solid state light sources that are inherently point sources. Many attempts have been made to make light bulb like LED lights, coupled with fixtures that diffuse the light to avoid bright spots. Uniform light emission is an important and desirable property for luminaires, as it is in backlights. Uniformity is particularly difficult with LEDs as the light source itself is more highly concentrated. It is particularly advantageous to arrange the light source along the edge of the luminaire out of the direct field of view. This approach allows the use of fewer more powerful LEDs, reducing the cost of the luminaire.

These and other possible constructions are generally required to produce light emitted into the field of view of the user that meets or exceeds application-specific requirements upon the brightness and the color of the emission, the spatial uniformity of these over the visible emissive surface of the backlight, and the dependence of brightness, color, and their uniformity upon the perspective from which the emissive surface is viewed. In addition, constructions must meet requirements for form factor (e.g. thickness), lifetime, durability, weight, efficiency, and thermal emissions, while respecting cost and manufacturability restraints.

Backlights for liquid crystal displays have traditionally had to satisfy particularly stringent optical performance requirements. These are such that the number of light sources incorporated in direct-lit constructions, and the thickness of these constructions, are dictated primarily by uniformity requirements, as opposed to brightness requirements. That is, direct-lit LCD backlights tend to incorporate many closely-spaced sources in a thick cavity to meet uniformity requirements, and target brightnesses are met even when the flux emitted by each source is relatively small. Edge-lit backlights, on the other hand, exploit guiding of light to achieve adequate uniformity with thin form factors. Here the challenge has been attaining a lineal density of source flux along the illuminated edges which is large enough to meet brightness requirements over the area of the display. The required lineal density increases linearly with the diagonal dimension of the display, and the cold cathode fluorescent lamps (CCFLs) used in most current LC displays cannot produce sufficient flux to meet brightness requirements in larger than approximately 26 inch diagonal displays. Thus, current CCFL-illuminated LC displays tend to be thin and edge lit for less than 26-inch formats, and thick and direct lit for formats larger than 26 inches.

The emergence of LEDs as viable light sources for back-lit displays dramatically alters the possibility for edge lighting large-format displays. Linear arrays of LEDs can easily produce ten times the lineal flux density of a single CCFL, making edge lighting conceivable for even the largest format displays and luminaires. The current cost structure of LEDs is such that the total source flux required to achieve specified brightnesses can be attained at a lower cost using a small number of high-flux devices, as opposed to a large number of low-flux devices. While direct-lit LED backlights require a large number of low-flux devices, edge-lit LED backlights can utilize either option. Thus, LED illumination facilitates thin edge-lit backlights for all displays. And edge lighting facilitates the lowest-cost alternative for LED backlights and luminaires.

Thus, there exists the need for edge-lit LED-illuminated backlights and luminaires that utilize a relatively small number of large-flux devices as sources, and which meet all of the optical performance and other requirements for liquid-crystal display backlights, graphic sign boxes and luminaires.

### BRIEF SUMMARY

The present disclosure relates to a perforated backlight and particularly to a highly efficient edge lit perforated backlight that provides uniform illumination. It should be understood that we define the term ‘backlight’ as a generic term referring to a light emitting article, where the light is being emitted from a surface. The surface could be used as a backlight for an LC display, graphic sign box, lighting luminaire, or other light emitting application. The surface could be flat, or non-flat depending on the application requirements.

In a first embodiment, a backlight includes a lower light guide having a specularly reflecting bottom surface and an opposing specularly reflecting perforated mirror film having a plurality of light transmission apertures. The specularly reflecting perforated mirror film has a polymeric multilayer structure, where non-perforated areas of the specularly reflecting perforated mirror film have a light reflectance value of 98% or greater and the specularly reflecting bottom surface has a light reflectance value of 98% or greater. A light collimating injector directs input light into the lower light guide. The light propagates generally parallel to the specularly reflecting perforated mirror film along a horizontal plane. The light collimating injector provides input rays into a vertical plane, the vertical plane being orthogonal to the horizontal plane, and forming an angle having an absolute value of 30 degrees or less with an intersection of the vertical and horizontal planes. An upper light cavity is disposed on the lower light guide. The upper light cavity has a light emission surface and a light input surface. The light input surface is at least partially defined by the specularly reflecting perforated mirror film. The upper light cavity has a thickness defined by the light emission surface and the light input surface. The thickness is equal to or greater than a distance between adjacent light transmission apertures.

In another embodiment, a backlight includes a lower light guide having a specularly reflecting bottom surface and an opposing specularly reflecting perforated mirror film having a plurality of light transmission apertures. The specularly reflecting perforated mirror film has a polymeric multilayer structure. Non-perforated areas of the specularly reflecting perforated mirror film have a light reflectance value of 99% or greater. The specularly reflecting perforated mirror film has an overall light absorptance value of 1% or less and the specularly reflecting bottom surface has a light reflectance value of 99% or greater. A light collimating injector directs input light into the lower light guide. The light propagates generally parallel to the specularly reflecting perforated mirror film along a horizontal plane. The light collimating injector provides input rays into a vertical plane, the vertical plane being orthogonal to the horizontal plane, and forming an angle having an absolute value of 30 degrees or less with an intersection of the vertical and horizontal planes.

### BRIEF DESCRIPTION OF THE DRAWINGS

The disclosure may be more completely understood in consideration of the following detailed description of various embodiments of the disclosure in connection with the accompanying drawings, in which:

FIG. 1 illustrates a schematic cross-sectional diagram of an illustrative backlight;

FIG. 2 illustrates a schematic plan view of illustrative perforated mirror film; and

FIG. 3 is a plot of absorptance verses light wavelength for precision die punched and laser cut mirror film.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description, reference is made to the accompanying drawings that form a part hereof, and in which are shown by way of illustration several specific embodiments. It is to be understood that other embodiments are contemplated and may be made without departing from the scope or spirit of the present invention. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

Light reflectance values and light absorptance values of the reflective films described herein are reported for visible light (between 380 and 780 nm), using a Perkin Elmer Lambda-900 spectrophotometer and the 150 mm integrating sphere accessory. Measurements were taken at both 8 and 45 degree incidence. Light reflectance values were measured using the reflectance configuration and baselining with a mirror standard.

Measurements of the light absorptance values (contribution from the apertures) were made using a center mount accessory to suspend the sample in the middle of the integrating sphere. The instrument was baselined with a white PTFE calibrated standard mounted on the reflectance port and the center mount in place without a sample. Sample measurements were made in both the total transmittance (mTT, having the white standard at the reflectance port) and diffuse transmittance (mDT, having the dark trap at the reflectance port) configurations. Measurements were made on samples that were larger than the illuminating beam, approximately 5 cm², and positioned to include several apertures in the beam. Subscripts p, u and 0 specify measurements made with a perforated mirror film (i.e., ESR), the corresponding unperforated mirror film, and no sample, respectively. The fraction of light transmitted through a sample and hitting the reflectance port (f) is given by the following relationship:

f=1−(mTTₚ−mDTₚ)/(mTTᵤ−mDTᵤ).

The subscript p and the subscript u specify the perforated and unperforated mirror films, respectively.

For an ideal perforated mirror film whose apertures do not contribute to absorption, mTT is given by the following relationship:

mTT_{ideal}=f*mTT₀+(1−f)*mTTᵤ.

Finally, the light absorptance value (Aₕ) for apertures of the perforated mirror film was calculated using the following relationship:

Aₕ=mTT_{ideal}−mTTₚ

Uniform light mixing is a challenge for direct-lit display architectures. It follows that the thickness of the backlight and the number of and/or disposition of light sources within the backlight are usually dictated by uniformity requirements, as opposed to brightness requirements. The result is thick cavities, and, in the case of LED sources, the use of many low-flux devices. Thick backlights are not desirable for most display applications, and the current cost structure of LEDs is such that for a given total required flux, the use of many low-flux devices is costly.

Edge-lit architectures can generally achieve adequate uniformity with thin form factors, and, in the case of LED sources, can utilize a relatively small number of high-flux devices, thus reducing cost relative to direct-lit displays. The provision of sufficient flux along one or two edges has been a challenge for larger-format displays, but linear arrays of LEDs can provide greater than 10 times more flux per unit length than CCFLs, so that LED-illuminated backlights can be edge illuminated even for very large formats. Thus, with LED sources, both cost and form factor favor edge-illumination.

The challenge is to develop specific edge-lit constructions that exhibit the right combination of optical performance, optical and mechanical robustness, ease of manufacture, form factor, weight, and component cost. The present disclosure accomplishes a desirable combination of these attributes by exploiting perforated mirrors to create many closely-spaced low-flux virtual LEDs illuminating a direct-lit upper cavity using a few high-flux LEDs illuminating an edge-lit hollow guide. While the present disclosure is not so limited, an appreciation of various aspects of the disclosure will be gained through a discussion of the examples provided below.

The present disclosure relates to perforated backlight and particularly to a highly efficient edge lit backlight that provides uniform illumination. These backlights can be utilized in a variety of applications such as, for example, liquid crystal displays and commercial graphic displays and luminaires. This disclosure provides an edge lit backlight that includes 1) a lower edge-illuminated hollow light guide whose upper surface is perforated by a multitude of small, closely-spaced apertures, and 2) an upper light cavity illuminated by light passing through the apertures, which can act as a recycling and mixing chamber to ensure uniform emission through its upper surface. The backlight is lined with highly efficient specular film and the perforated portion is also highly efficient specular film for light in both the lower light guide and upper light cavity. The backlight is illuminated by a series of discrete and/or continuous light sources disposed along one or more of its edges, configured (by the design of the light source or the containing structure) to provide illumination which is at least partially collimated about the horizontal direction (a parallel direction to the perforated highly efficient specular film) within planes normal to the illumination edge(s).

The collimation (which is preserved by the highly efficient specular film character of the light guide) in combination with the high reflectivity of the film promotes a substantially uniform flux through the perforations regardless of their normal distance from the illuminated edge(s). That is, consider a horizontal plane parallel to the perforated highly efficient specular film and a vertical plane orthogonal to the horizontal plane, then the projection of input rays into this vertical plane will form an angle with the intersection of the vertical and horizontal planes such that the absolute value of this angle is less than 30 degrees or less than 20 degrees or less than 15 degrees. Such collimation is achieved by structures (e.g., reflectors or lenses) that are invariant with respect to translation parallel to the illuminated edges.

Sufficiently uniform flux can be maintained with realizable reflectivities and degrees of collimation over normal distances that are more than 30 times the depth of the backlight, permitting either a shallow guide or a large-format backlight. The collimation also provides a radiant intensity through the perforations which is substantially directed away from the upward normal to the perforated highly efficient specular film surface. The upper light cavity can function as a direct lit backlight illuminated by an array of closely-spaced side emitting light sources of substantially uniform flux. In many embodiments, the emissive surface of the upper light cavity can include a partially-reflecting and partially transmitting diffusing element to promote recycling and mixing, and may contain a gain-enhancement component and/or a reflective polarizer, as desired. Uniform emission through the emission surface can be assured by an upper light cavity depth that is equal to or exceeds the spacing between the closely-spaced apertures of the perforated highly efficient specular film. Thus, this close aperture spacing permits the adoption of a shallow upper cavity while preserving the uniformity of emission.

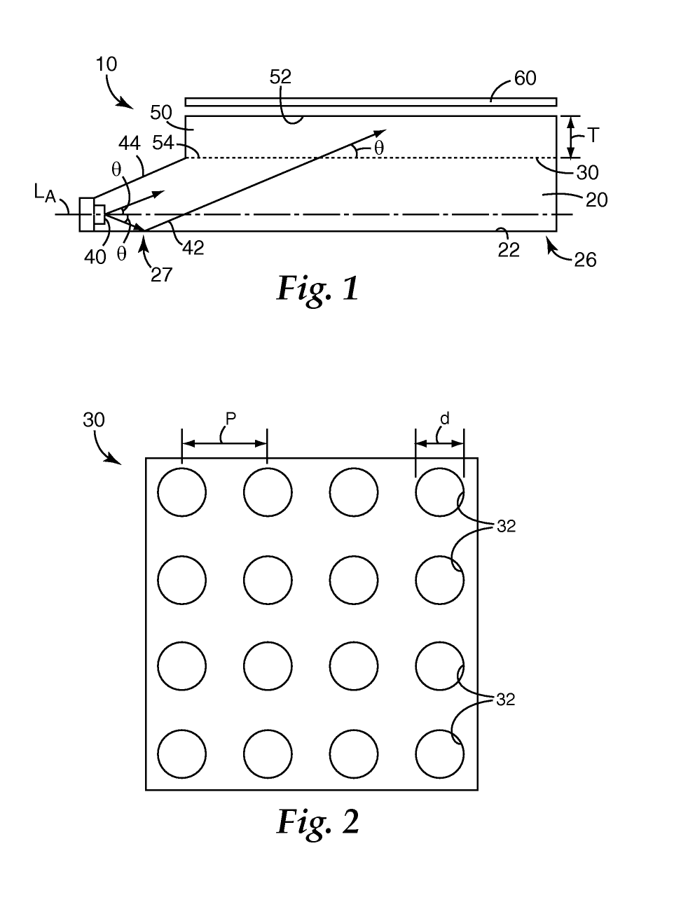

FIG. 1 illustrates a schematic cross-sectional diagram of an illustrative backlight 10 and FIG. 2 illustrates a schematic plan view of illustrative perforated mirror film 30. The backlight includes a lower light guide 20 having a specularly reflecting bottom surface 22 and an opposing specularly reflecting perforated mirror film 30 having a plurality of light transmission apertures 32. In some embodiments, the specularly reflecting bottom surface 22 and the opposing specularly reflecting perforated mirror film 30 are parallel surfaces. The specularly reflecting perforated mirror film 30 has a multilayer polymeric structure. Non-perforated areas of the specularly reflecting perforated mirror film 30 have a light reflectance value of 98% or greater. The specularly reflecting perforated mirror film 30 has an overall light absorptance value of 2% or less. In other embodiments, the specularly reflecting perforated mirror film 30 has non-perforated areas of the specularly reflecting perforated mirror film with a light reflectance value of 99% or greater, or 99.5% or greater. The specularly reflecting perforated mirror film 30 has an overall light absorptance value of 1% or less, or 0.5% or less. The specularly reflecting bottom surface 22 has a light reflectance value of 98% or greater, or 99% or greater, or 99.5% or greater. The “overall” light absorptance refers to the absorptance exhibited when a spot containing several perforations is illuminated—that is, the average absorptance over both the non-perforated regions and the perforations.

In many embodiments, all of the surfaces defining the lower light guide 20 are formed of the specularly reflecting mirror film (with the upper surface defined by the specularly reflecting perforated mirror film 30) having a light reflectance value of 99% or greater and a light absorptance value of 1% or less, or a light reflectance value of 99.5% or greater and a light absorptance value of 0.5% or less. Light reflectance, absorptance, and light transmittance are all generally independent of the incidence light angle on the surface of the specularly reflecting mirror film (described in more detail herein).

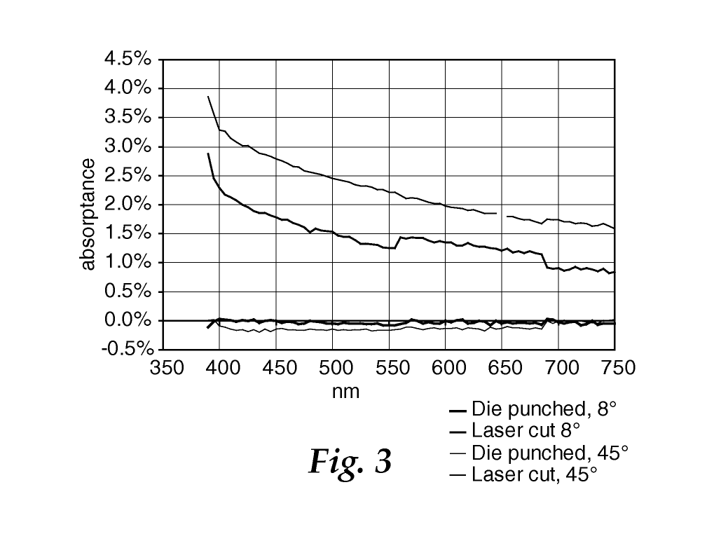

While the perforations or light transmission apertures 32 allow continuous adjustment of the overall reflectance and transmittance of the upper surface defined by the specularly reflecting perforated mirror film 30, these perforations or light transmission apertures 32 introduce virtually no additional light absorptance into the upper surface defined by the specularly reflecting perforated mirror film 30 (see FIG. 3, described below).

A light source 40 or light collimating injector 40 directs input light 42 into the lower light guide 20 via a collimating structure 44. The collimated light 42 propagates generally parallel to the specularly reflecting perforated mirror film 30. That is, consider a horizontal plane (e.g., input axis plane L_{A}) parallel to the perforated highly efficient specular film 30 and a vertical plane orthogonal to the horizontal plane, then the projection of input rays into this vertical plane will form an angle θ with the intersection of the vertical and horizontal planes such that the absolute value of this angle is less than 30 degrees or less than 20 degrees or less than 15 degrees.

The light source or collimating injector 40 can also be described as providing a 60 degree or less light cone (2 times the angle θ), or a 50 degree or less light cone (2 times the angle θ), or a 40 degree or less light cone (2 times the angle θ), or a 30 degree or less light cone (2 times the angle θ), or a 20 degree or less light cone (2 times the angle θ). The collimated injector 40 can be any useful light source. In many embodiments, the light source is a solid state light source such as, for example, a light emitting diode.

The light source or collimating injector 40 can provide collimated light (light propagating parallel to the light input axis L_{A} and within a desired light cone (2 times the angle θ) via any useful light collimating means such as, for example, a wedge light injection structure 44 (as illustrated) or a parabolic light injection structure, or an appropriate lens structure. In many embodiments, the light source or collimating injector 40 directs input light 42 into only one side 27 or edge of the lower light guide 20. Thus, an opposing side 26 of the lower light guide 20 does not include a light source. In other embodiments, one or more additional collimated light sources direct light into other side(s) or edge(s) of the lower light guide 20. A large area backlight 10 can have collimated light sources providing light into the lower light guide on opposing edges or sides of the lower light guide, in particular embodiments; the backlight can have collimated light sources providing light into all four sides of the lower light guide.

Input light 42 transmits through the lower light guide 20 and exits the lower light guide 20 through the light transmission apertures 32 at an angle θ to the specularly reflecting perforated mirror film 30, of 30 degrees or less, or 25 degrees or less or 20 degrees or less or 10 degrees or less (as determined by the light cone angle of the light source or collimating injector 40, described above). Thus, the light transmission apertures 32 operate as a virtual side emitting light source. These virtual side emitting light sources are useful because they promote light uniformity even for upper cavity 50 thickness T values that are less than the pitch P value between the light transmission apertures 32.

In other embodiments, the light transmission apertures 32 operate as Lambertian emitters if a partially-transmitting diffusing film (not shown) is positioned on or next to the surface of the specularly reflecting perforated mirror film 30. This partially-transmitting diffusing film can be applied over all or only a portion the light transmission apertures 32, as desired. In some embodiments, light transmission apertures 32 adjacent the illuminated edges of the backlight can be modified to operate as Lambertian emitters, as described above, to reduce local darkening in the backlight emission at the illuminated edges of the backlight. Lambertian emission is by its nature symmetric, and can mitigate local darkening when incorporated near illuminated edges. Laminated or overlying diffusing films on the light transmission apertures 32 can also be useful where imperfections in the lower light guide 20 create spurious pencils of light outside of the 60 degree light cone established by the collimating injector 40. The diffuser film spreads this light as it traverses the upper cavity 50, preventing the creation of a bright spot in the display light emission.

In many embodiments, a relatively small number of light sources or collimating injectors 40 direct input light 42 into the lower light guide 20, as compared to the total number of light transmission apertures 32 provided in the specularly reflecting perforated mirror film 30. In many embodiments, a plurality of high intensity LEDs are provided as collimated (θ equal to or less than 30 degrees) edge-lit light sources and a large number (100 to 500 apertures per LED) of light transmission apertures 32 provided in the specularly reflecting perforated mirror film 30. This configuration provided a large number (100 to 500 apertures per LED) of virtual (to a viewer) side emitting (0 equal to or less than 30 degrees, or θ equal to or less than 25 degrees, or θ equal to or less than 20 degrees, or θ equal to or less than 10 degrees) light sources. In one particular embodiment, 78 high brightness LEDs are converted to 22,000 small virtual side emitting LEDs having a 1200 micrometer diameter d with a 3600 micrometer pitch P.

The upper light cavity 50 is disposed on the lower light guide 20. The upper light cavity 50 has a light emission surface 52 and a light input surface 54. The light input surface 54 is at least partially defined by the specularly reflecting perforated mirror film 30. The upper light cavity 50 has a thickness T defined by a distance between the light emission surface 52 and the light input surface 54. The thickness T being equal to or greater than a distance or period P between adjacent light transmission apertures 32. In other embodiments, the thickness T is equal to or less than a distance or period P between adjacent light transmission apertures 32.

The lower light guide 20 and/or the upper light cavity 50 can be a hollow reflective cavity or formed of a solid material, as desired. In many embodiments, the lower light guide 20 is a hollow cavity. In many embodiments, the lower light guide 20 and the upper light cavity 50 are a hollow reflective cavities. In other embodiments, the lower light guide 20 is a hollow reflective cavity and the upper light cavity 50 is formed from a solid material. The solid materials that form the upper light cavity 50 can be any useful light transmissive material such as, for example, a polymeric material or a glass.

The advantages, characteristics and manufacturing of specularly reflecting mirror film are most completely described in U.S. Pat. No. 5,882,774, which is incorporated herein by reference. A relatively brief description of the properties and characteristics of these specularly reflecting mirror films is presented herein.

Multilayer polymeric specularly reflecting mirror films as used in conjunction with the present disclosure (for example, the specularly reflecting bottom surface 22 and the specularly reflecting perforated mirror film 30, along with the remaining side surfaces that form the lower light guide 20 and/or the upper light cavity 50) exhibit low absorption of incident light, as well as high reflectivity for off-axis as well as normal light rays. The unique properties and advantages of these multilayer optical films provide an opportunity to design highly efficient backlight systems that exhibit low absorption losses when compared to known backlight systems. These multilayer polymeric specularly reflecting mirror films are efficient light reflectors (98% or greater, or 99% or greater reflectance) for visible light of any visible light wavelength (i.e., 380 to 780 nm) having any angle of incidence on the surface of the multilayer polymeric specularly reflecting mirror film.

Exemplary multilayer polymeric specularly reflecting mirror films include a multilayer stack having alternating layers of at least two materials. At least one of the materials has the property of stress induced birefringence, such that the index of refraction of the material is affected by the stretching process. The difference in refractive index at each boundary between layers will cause part of the light ray to be reflected. By stretching the multilayer stack over a range of uniaxial to biaxial orientations; a film is created with a range of reflectivities for differently oriented plane-polarized incident light. The multilayer stack can thus be used as a mirror. These polymeric specularly reflecting mirror films exhibit a Brewster angle (the angle at which reflectance goes to zero for light incident at any of the layer interfaces) which is very large or is nonexistent. In contrast, known multilayer polymer films exhibit relatively small Brewster angles at layer interfaces, resulting in transmission of light and/or undesirable iridescence. The principles and design considerations described in U.S. Pat. No. 5,882,774 can be applied to create multilayer stacks having the desired specularly reflecting mirror effect. The multilayer polymeric specularly reflecting mirror film stack can include tens, hundreds or thousands of layers, and each layer can be made from any of a number of different materials.

For polymeric specularly reflecting mirror film applications, the desired average transmission for light of each polarization and plane of incidence generally depends upon the intended use of the reflective film. One way to produce a multilayer mirror film is to biaxially stretch a multilayer stack that contains a birefringent material as the high index layer of the low/high index pair. For a high efficiency reflective film, average transmission along each stretch direction at normal incidence over the visible spectrum (380-780 nm) is desirably less than 2% (reflectance greater than 98%), or less than 1% (reflectance greater than 99%), or less than 0.5% (reflectance greater than 99.5%). These polymeric specularly reflecting mirror films are commercially available under the trade designation VIKUITI™ ENHANCED SPECULAR REFLECTOR (ESR), from 3M Company, Saint Paul, Minn.

These polymeric specularly reflecting mirror films are precision die cut to form the apertures 32 of the specularly reflecting perforated mirror film 30. The precision die cutting of the polymeric specularly reflecting mirror film introduces virtually no additional light absorptance (at wavelengths from 380 to 780) to the specularly reflecting perforated mirror film 30. The efficiency of the lower guide 20 can be determined by 1) the average number of interactions with the top and bottom surfaces that occur subsequent to entering and prior to exiting the guide, and 2) the absorptance experienced for each bounce. If there are, say, 10 interactions, the efficiency is (0.995)5×(0.995)5=0.95 when the absorptance of both the top and bottom surfaces is 0.5%, but only (0.995)5×(0.970)5=0.84 when the absorptance of the top surface is 3%. Thus, it is important to perforate without introducing additional absorptance.

This allows the lower light guide to maintain an efficiency of 98% or greater or 99% or greater, or even 99.5% or greater (at wavelengths from 380 to 780). In many embodiments, the specularly reflecting perforated mirror film 30 has a light absorptance of 0.5% or less, or 0.4% or less, or 0.3% or less, or 0.2% or less, or 0.1% or less (at wavelengths from 380 to 780).

As illustrated in FIG. 3, light absorptance of polymeric specularly reflecting mirror film having precision die punched apertures (around 0% for 380 to 750 nm light) is significantly lower than light absorptance of polymeric specularly reflecting mirror films having laser cut apertures (from 3-4% at 380 nm light down to 0.8-1.5% at 750 nm light). This reduced light absorptance exhibited by precision die cut polymeric specularly reflecting mirror films provide a dramatic increase in light efficiency of the backlight.

While the apertures 32 are illustrated in FIG. 2 as having a circular definition, the apertures 32 can have any useful regular or irregular shape such as, for example, a polygon, or ellipse, and the like. In many embodiments, the distance P between the apertures 32 is regular. In other embodiments, the distance P between the apertures 32 increases or decreases along a width (from the first side 24 to the second side 26) of the specularly reflecting perforated mirror film 30.

In many embodiments, the specularly reflecting perforated mirror film 30 has a total area, and the light transmission area (defined by the open area or perforation area defined by the aperture 32 voids) is in a range from 5 to 20% of the total area of the reflecting perforated mirror film 30. In many embodiments, the aperture percent of total area is constant across the total area. In other embodiments, the aperture percent of total area increases or decreases across the total area or varies with position relative to the illuminated edges of the backlight. In these embodiments, the fractional area occupied by the apertures varies across the total area while the pitch or center to center distance of the apertures is maintained.

The apertures 32 can have any useful size d and distance P between the apertures 32. In some useful embodiments, circular apertures have a size d value about ⅓ of the distance or pitch P value between apertures. In particular embodiments, the apertures have a size d in a range from 100 to 3000 micrometers or from 500 to 1500 micrometers and a distance or pitch P between apertures (center to center) in a range from 300 to 9000 micrometers or from 1500 to 4500 micrometers. The aperture 32 center to center pattern or disposition can be any useful pattern or disposition. In many embodiments, the aperture 32 center to center pattern or disposition is a cubic pattern such as, for example a hexagonal pattern. In other embodiments, the aperture 32 center to center pattern or disposition is a non-cubic pattern.

The backlight 10 may further include an optional optical element 60. The optical element 60 can be one or more optical element such as, for example, a light crystal display panel, a graphic film, a diffuser, an enhancement film having prismatic surface structures, such as is available under the trade designation VIKUITI™ BRIGHTNESS ENHANCEMENT FILM (BEF), available from 3M Company, polarizers (e.g., reflective polarizers and/or absorbing polarizers), and/or the like. The reflective polarizer can be a multilayer reflective polarizer, such as is available under the trade designation VIKUITI™ DUAL BRIGHTNESS ENHANCEMENT FILM (DBEF), also available from 3M Company. The reflective polarizer transmits light with a predetermined polarization, while reflecting light with a different polarization into the backlight 10 where the polarization state is altered and the light is then directed back to the reflective polarizer.

All references and publications cited herein are expressly incorporated herein by reference in their entirety into this disclosure, except to the extent they may directly contradict this disclosure. Illustrative embodiments of this disclosure are discussed and reference has been made to possible variations within the scope of this disclosure. These and other variations and modifications in the disclosure will be apparent to those skilled in the art without departing from the scope of the disclosure, and it should be understood that this disclosure is not limited to the illustrative embodiments set forth herein. Accordingly, the disclosure is to be limited only by the claims provided below.

What is claimed is:

1. A backlight comprising:
a lower light guide having a specularly reflecting bottom surface and an opposing specularly reflecting perforated mirror film having a plurality of light transmission apertures, the specularly reflecting perforated mirror film having a polymeric multilayer structure, where non-perforated areas of the specularly reflecting perforated mirror film have a light reflectance value of 98% or greater and the specularly reflecting bottom surface has a light reflectance value of 98% or greater;
a light collimating injector directing input light into the lower light guide, the light propagating generally parallel to the specularly reflecting perforated mirror film along a horizontal plane, the light collimating injector providing input rays into a vertical plane, the vertical plane being orthogonal to the horizontal plane, and forming an angle having an absolute value of 30 degrees or less with an intersection of the vertical and horizontal planes; and
an upper light cavity disposed on the lower light guide, the upper light cavity having a light emission surface and a light input surface, the light input surface at least partially defined by the specularly reflecting perforated mirror film, the upper light cavity having a thickness defined by the light emission surface and the light input surface, the thickness being equal to or greater than a distance between adjacent light transmission apertures.

2. A backlight according to claim 1, wherein the specularly reflecting perforated mirror film has a polymeric multilayer structure, wherein non-perforated areas of the specularly reflecting perforated mirror film have a light reflectance value of 99% or greater and the specularly reflecting perforated mirror film has a light absorptance value of 1% or less and the specularly reflecting bottom surface has a light reflectance value of 99% or greater.

3. A backlight according to claim 1, wherein the light collimating injector comprises light emitting diodes.

4. A backlight according to claim 1, wherein the specularly reflecting perforated mirror film has a total area and a light transmission area is in a range from 5 to 20% of the total area.

5. A backlight according to claim 1, further comprising a light diffuser layer disposed on or adjacent to the specularly reflecting perforated mirror film.

6. A backlight according to claim 1, wherein the light collimating injector directing input light into the lower light guide directing light into only one side of the lower light guide.

7. A backlight according to claim 1, wherein the lower light guide is a hollow light guide.

8. A backlight according to claim 1, wherein the lower light guide is a hollow light guide and the upper light cavity is a solid light cavity.

9. A backlight according to claim 1, wherein the lower light guide is a hollow light guide and the upper light cavity is a hollow light cavity.

10. A backlight according to claim 1, wherein input light transmits through the apertures at an angle to the specularly reflecting perforated mirror film of 30 degrees or less.

11. An LCD display with a backlight according to claim 1.

12. An illuminated graphic image with a backlight according to claim 1.

13. A luminaire with a backlight according to claim 1.

14. A backlight comprising:
a lower light guide having a specularly reflecting bottom surface and an opposing specularly reflecting perforated mirror film having a plurality of light transmission apertures, the specularly reflecting perforated mirror film having a polymeric multilayer structure, where non-perforated areas of the specularly reflecting perforated mirror film have a light reflectance value of 99% or greater and the specularly reflecting perforated mirror film has a light absorptance value of 1% or less and the specularly reflecting bottom surface has a light reflectance value of 99% or greater; and
a light collimating injector directing input light into the lower light guide, the light propagating generally parallel to the specularly reflecting perforated mirror film along a horizontal plane, the light collimating injector providing input rays into a vertical plane, the vertical plane being orthogonal to the horizontal plane, and forming an angle having an absolute value of 30 degrees or less with an intersection of the vertical and horizontal planes.

15. A backlight according to claim 14, further comprising an upper light cavity disposed on the lower light guide, the upper light cavity having a light emission surface and a light input surface, the light input surface at least partially defined by the specularly reflecting perforated mirror film, the upper light cavity having a thickness defined by the light emission surface and a light input surface.

16. A backlight according to claim 14, wherein non-perforated areas of the specularly reflecting perforated mirror film have a light reflectance value of 99.5% or greater and the specularly reflecting perforated mirror film has a light absorptance value of 0.5 or less and the specularly reflecting bottom surface has a light reflectance value of 99.5% or greater.

17. A backlight according to claim 14, wherein the light collimating injector comprises one light emitting diode for every 100 to 500 apertures.

18. A backlight according to claim 14, wherein the specularly reflecting perforated mirror film has a total area and a light transmission area is in a range from 5 to 15% of the total area.

19. A backlight according to claim 14, further comprising a light diffuser layer disposed on or adjacent to the specularly reflecting perforated mirror film.

20. A backlight according to claim 14, wherein the light collimating injector directing input light into the lower light guide directing light into only one side of the lower light guide.

21. A backlight according to claim 14, wherein the lower light guide is a hollow light guide.

22. A backlight according to claim 15, wherein the lower light guide is a hollow light guide and the upper light cavity is a solid light cavity.

23. A backlight according to claim 15, wherein the lower light guide is a hollow light guide and the upper light cavity is a hollow light cavity.

24. A backlight according to claim 14, wherein input light transmits through the apertures at an angle, to the specularly reflecting perforated mirror film, of 30 degrees or less.

25. An LCD display with a backlight according to claim 14.

26. An illuminated graphic image with a backlight according to claim 14.

27. A luminaire with a backlight according to claim 14.
